(19) United States
(12) Patent Application Publication
(10) Pub. No.: US 2025/0328445 A1
(43) Pub. Date: Oct. 23, 2025

(54) Index Advisor For Online Transaction Processing Workloads In Database Management Systems

(71) Applicant: Oracle International Corporation, Redwood Shores, CA (US)

(72) Inventors: Urvashi Oswal, Fremont, CA (US); Fatjon Zogaj, Zurich (CH); Aydin Faraji, Chur (CH); Onur Kocberber, Thalwil (CH); Seema Sundara, Nashua, NH (US); Nipun Agarwal, Saratoga, CA (US)

(21) Appl. No.: 18/642,008

(22) Filed: Apr. 22, 2024

(51) Int. Cl. G06F 11/34

(52) U.S. Cl. CPC G06F 11/3414; G06F 11/3428

(57) ABSTRACT

A machine learning (ML) based index advisor is provided to help optimize database systems for better cost and performance. The index advisor considers both the performance of queries and the cost of maintaining the indexes. It also provides performance and storage estimates, as well as explanations for the recommendations that are generated. The index advisor generates an index recommendation by generating a set of candidate indexes and applying a trained ML model to operations in the workload and each candidate index to determine a predicted performance benefit. The index advisor determines a total performance benefit for each candidate index.

### FIELD OF THE INVENTION

The present invention relates to automatic index recommendations for online transaction workloads in a database management system.

### BACKGROUND

Online Transaction Processing (OLTP) is a type of data processing that consists of executing a number of transactions occurring concurrently, such as online banking, shopping, order entry, or sending text messages, for example. In the past, OLTP was limited to real-world interactions in which something was exchanged, such as money, products, information, request for services, and so on; however, the definition of transaction in this context has expanded over the years, especially since the advent of the internet, to encompass any kind of digital interaction or engagement with a business that can be triggered from anywhere in the world and via any web-connected sensor. OLTP also includes any kind of interaction or action such as downloading pdfs on a web page, viewing a specific video, or automatic maintenance triggers or comments on social channels that maybe critical for a business to record to serve their customers better.

Indexes are used to quickly look up rows with specific column values. Without an index, the entire table must be scanned to find the relevant rows. This table scan can be costly, especially for larger tables. If the table has an index for the columns in question, the position of the relevant rows can quickly be determined without having to look at all the data.

Creating an optimal set of indexes has always been a challenging task for database administrators (DBAs). On the one hand, creating too few indexes can result in low query performance, especially for SELECT statements. On the other hand, creating too many indexes leads to excessive index maintenance during data manipulation language statements (DMLs), in turn again hampering performance. Furthermore, the existence of too many indexes takes up storage and can also cause the query compilation to slow down as the optimizer tries to evaluate the best index candidate for a given table/query.

For DBAs to recommend indexes, not only do they need to have a deep understanding of how indexes impact the various query constructs like WHERE predicates, JOINs, ORDER BY etc., they need to come up with an optimal and minimal set of indexes for a given workload that also maintains a balance between performance and storage. In addition, if the user workload changes, the DBA must revisit the index choices all over again, making the task quite daunting.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

### BRIEF DESCRIPTION OF THE DRAWINGS

In the drawings:

FIG. 1 illustrates a machine learning based index advisory that generates create and drop recommendations in accordance with an illustrative embodiment.

FIG. 2 is a flowchart illustrating machine learning model training for index recommendations in accordance with an illustrative embodiment.

FIG. 3 is a block diagram illustrating a machine learning based index advisor for generating index recommendations in accordance with an illustrative embodiment.

FIG. 4 illustrates an example of piecewise linear regression models based on the number of rows in accordance with an illustrative embodiment.

FIG. 5 is a flowchart illustrating an index advisor generating an index recommendation in accordance with an illustrative embodiment.

FIG. 6 illustrates the benefits of using an index advisor in accordance with the illustrative embodiments.

FIG. 7 shows a table presenting results after running the index advisor on already-tuned benchmark configurations at system start in accordance with an illustrative embodiment.

FIG. 8 is a block diagram that illustrates a computer system upon which aspects of the illustrative embodiments may be implemented.

FIG. 9 is a block diagram of a basic software system that may be employed for controlling the operation of a computer system in accordance with an illustrative embodiment.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

The illustrative embodiments provide a machine learning (ML) based index advisor designed to help optimize database systems for better cost and performance. With the index advisor, database administrators no longer need to manually identify which indexes are most beneficial for a particular workload. The index advisor automatically generates secondary index recommendations for creating and dropping indexes based on the workload. The index advisor considers both the performance of queries and the cost of maintaining the indexes. It also provides performance and storage estimates, as well as explanations for the recommendations that are generated. In one embodiment, the index advisor automatically implements the index recommendations by creating or dropping indexes.

Deciding the optimal indexes is not a trivial task since it depends on many factors and gets complicated very quickly with the size of dataset/workload. Automating the decision significantly improves user experience and alleviates the burden of choosing secondary indexes. The approach of the illustrative embodiments further improves user experience by providing explanations for suggestions in terms of affected queries, and the expected benefit of applying the index recommendation in terms of performance improvement and storage requirements. The recommended indexes directly improve the performance of some queries by up to 1000× because it alleviates the need to scan all the rows in the table. Better performance leads to the queries running faster (lower elapsed time), so the customers benefit by paying for less compute time.

### Machine Learning Based Index Advisor

In MySQL InnoDB engine, for example, base tables are already a B-Tree structure based on the primary keys that are either user-specified or auto generated. Hence, data lookup based on the primary keys is very efficient. However, for many OLTP workloads, secondary indexes also play a crucial role in performance tuning. Unfortunately, secondary indexes are harder to determine for humans as they resemble complex data relationships. The illustrative embodiments provide an index advisor that focuses on the recommendations of these secondary indexes based on the workload.

There have been decades of research to automate index selection. Previous research for finding optimal indexes has focused on using “what-if” heuristics/cost-estimates from the optimizer to find the missing indexes. Heuristics or cost-estimates can sometimes be far from reality and do not make use of the real execution times that are available from the query history. This can quickly get very expensive and does not share information across workloads. Unlike prior systems that rely on “what-if” approaches and/or create hypothetical indexes by relying on the query optimizer's cost estimation for index selection, the index advisor of the illustrative embodiments uses feature vectors generated from query plans along with machine learning models to estimate the performance impact of index candidates.

To implement a practical and accurate predictor, the approach of the illustrative embodiments combines both real-time and heuristic based statistics for the existing query plans to estimate the performance for other index candidates using offline-trained machine learning models. Finally, it recommends the index candidates with highest estimated benefit. The advisor also provides the expected benefit of the recommended indexes in terms of performance improvement and storage requirements.

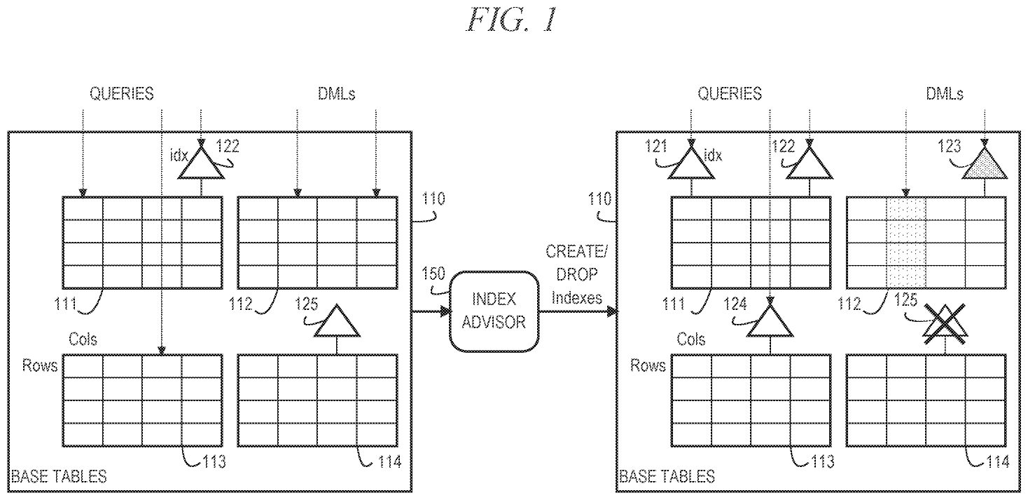

FIG. 1 illustrates a machine learning based index advisory that generates create and drop recommendations in accordance with an illustrative embodiment. In the depicted example, base tables 110 include tables 111, 112, 113, 114. The workload includes queries that reference tables 111, 113 and DMLs that reference table 112. Before applying index recommendations, base tables 110 have indexes 122 and 125. As shown in FIG. 1, there are queries that reference columns of tables 111, 113 that are not indexed, and index 125 is for a column that is not referenced by the workload.

Index advisor 150 considers both query and DML performance (index maintenance cost), generates both CREATE and DROP recommendations of indexes, and generates index recommendations across all classes of datasets and workloads without the need to retrain the models for new datasets. Index advisor 150 provides the expected benefit of applying the index recommendations in terms of performance improvement (per query and total workload) over the existing indexes or base table scans, provides explanation for the recommendations in terms of the affected queries, and provides storage prediction for the recommended indexes before creating them.

The machine learning (ML) approach of index advisor 150 models desired optimization targets (throughput, latency, storage). As a result, the index advisor 150 can model performance impact without creating the indexes (metadata or the data) and impose no compute or storage overhead on customer instance. Furthermore, index advisor 150 does not need to execute the queries in the background to validate the new index candidates.

After application of index recommendations generated by index advisor 150, indexes 121, 122, 124 are generated for the columns referenced by the queries in the workload. Index 123 is generated for columns referenced by DMLs in the workload, and index 125 is dropped. That is, index advisor 150 generates a create recommendation to create indexes 121, 124 and a drop recommendation to drop index 125.

Some embodiments focus on index recommendations for OLTP workloads running on MySQL. The approach of these embodiments supports recommendations of B-Tree indexes. The approach depends on post-query-execution logs to make a recommendation; therefore, it requires the data to be loaded and a representative set of queries to be executed before making a recommendation. The approach requires a significant representative workload executed beforehand. In one embodiment, an implementation requires at least five queries executed before making any index recommendation. For online analytical processing (OLAP) workloads, the index advisor generates limited recommendations for complex OLAP queries.

Unlike past work that solely depends on heuristics and cost estimates obtained from the query plans using hypothetical “what if” optimizer calls, the approach of the illustrative embodiments combines the real execution times and statistics from previously executed queries along with machine learning estimates to make accurate index recommendations specific to the dataset and workload. The approach provides DROP index recommendations for duplicate and unused indexes, in addition to CREATE index recommendations. The approach is generalizable across different workload, dataset, server, cloud environment characteristics without requiring retraining of the models for new datasets and considers the cost of index maintenance on DML activity for index selection.

Unlike other work that uses reinforcement/active learning, the approach of the illustrative embodiments does not require running queries repeatedly for validating different index combinations, and hence avoids the cost of building indexes for the tables and repeatedly executing workloads. This is achieved by training regression models to predict the index benefit of materializing candidate indexes. This takes trial-and-error out of picking optimal indexes. The approach provides explanations for the index recommendations in terms of affected queries.

Unlike other works that rely on hypothetical indexes or metadata, the approach of the illustrative embodiments uses machine learning to estimate the impact of applying the index suggestions. The approach provides the expected benefit of applying the index recommendation in terms of performance improvement (per query and total workload) over the existing indexes, and the storage impact of applying the index recommendations. The approach does not require a separate compute cluster and runs on the customer instance without disturbing the workloads.

In some embodiments, the approach uses piecewise linear regression models to predict query execution times which may range from few milliseconds to hundreds of seconds. Piecewise models allow the models to focus on the most common cases (queries with execution times in milli-seconds), but also cover rare cases (queries with longer execution times). As such, the models have a bigger influence on model parameters.

The index advisor uses machine learning to predict the performance of queries and DML statements with different candidate indexes. This allows the system to make informed recommendations for creating and dropping indexes based on the predicted performance improvements. The machine learning models are trained on historical offline data and are constantly updated across versions to ensure that they are accurate and up to date with the latest version of the MySQL database system. The process of index recommendation consists of the following two stages:
1. Offline: Machine learning model training.
2. Online: Given an executed workload/query history:
   a. Generate candidate list: Extract a list of attributes in the WHERE clause, ORDER BY clause and SELECT lists for the given workload, which is used to generate index candidates.
   b. Index selection: Rank the index candidates by estimated performance benefit and storage requirements, and then pick the top index candidates to recommend, that fit in storage budgets.

The offline training stage consists of gathering query times for multiple datasets. The goal is to gather sufficient information on performance across variety of data sizes and workloads. The gathered dataset is then used for training a performance model. The online stage currently consists of two parts. Given an executed workload history, in the first phase, a list of candidate indexes is generated based on the WHERE, SELECT, and ORDER BY columns. The candidate keys are a subset of the WHERE, SELECT, or ORDER BY keys. During an inference stage, given the ML models and a new workload, the models are used to predict the workload performance for each candidate index. Finally, the index combination with highest estimated benefit is recommended to the user. The remainder of this section provides the details for each of the steps described above.

### Model Training

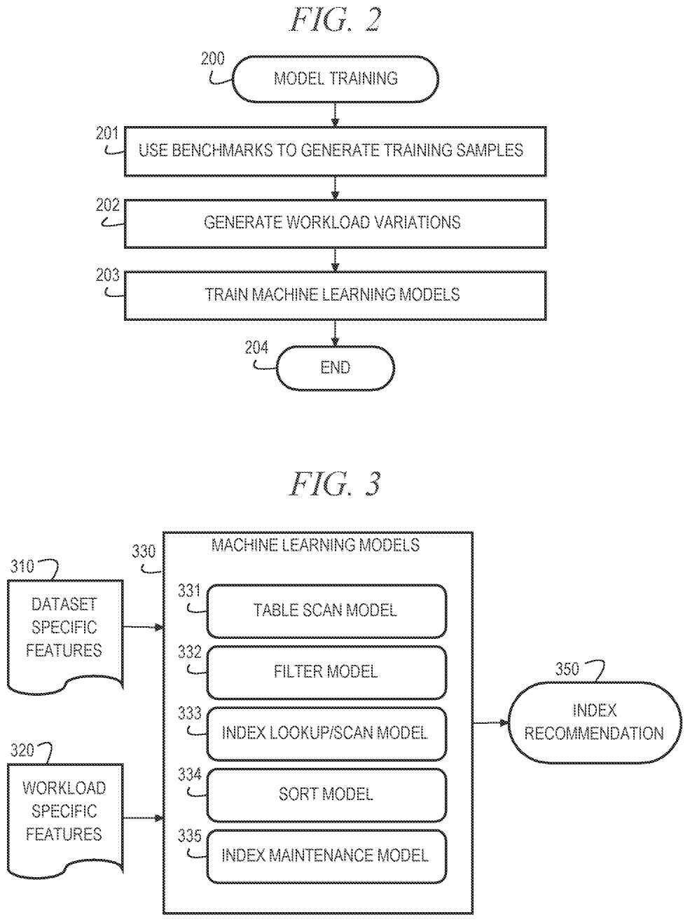

FIG. 2 is a flowchart illustrating machine learning model training for index recommendations in accordance with an illustrative embodiment. The ML models of the illustrative embodiments are adaptable and generalizable across different workloads, datasets, servers, or cloud environment characteristics. To do so, the illustrative embodiments employ a continuous learning process based on generated data that resembles the workload activity in the cloud service. As a result, the ML models are constantly updated via a large variety of workload and cloud activity, and new models are generated automatically for every release.

Operation begins for model training (block 200), and the model training uses benchmarks to generate training samples (block 201). The model training also generates workload variations (block 202). The generated data provides workload variability. Given a dataset, the approach of the illustrative embodiments systematically generates hundreds of workload variations that are used to generate the performance prediction dataset for the ML model. These workloads are a combination of both random and default queries. The generated data also provides dataset variability. The approach of the illustrative embodiments gathers a dataset across a large corpus of datasets that covers a wide variety of dataset shapes for better generalization, allowing the model to work for any dataset.

The training data spans different workload size/mix, cardinality, number of tables and size distribution, selectivity of predicates, selectivity of join results, etc. This allows the trained model to generalize better to new unseen datasets. The illustrative embodiments generate different workloads to cover the training space appropriately. The training samples are generated using the following methods:
1. Benchmarks: Training samples can be generated using benchmarks such as TPCC, AuctionMark, SEATS, Smallbank, and Epinions, for example, with different scale factors (1G, 5G, 10G) with different shapes as appropriate. Each query is executed multiple times for warm up.
2. Automated workload generation: Given a dataset, Training samples can be generated by systematically generating hundreds of workload variations to generate the performance prediction dataset for the ML model. These workloads are a combination of both random and default queries.

TPC Benchmark C (TPCC) is an OLTP benchmark. TPC-C involves a mix of five concurrent transactions of different types and complexity either executed on-line or queued for deferred execution. The database is comprised of nine types of tables with a wide range of record and population sizes. AuctionMark benchmark is an OLTP workload that simulates the activities found in a well-known auction site. This benchmark comprises of 13 tables and 14 stored procedures representing the auction site's core transactions. SEATS simulates a scenario based on an airline reservation system. SEATS generates transactional scenarios, including seat reservations, ticket purchases, and flight status checks, offering insights into database efficiency in the context of airline operations. SmallBank emulates the workload of a small banking application, stressing the database with various financial transactions, account operations, and user interactions. SmallBank generates transactions like deposits, withdrawals, and fund transfers, simulating the transactional nature of small-scale banking operations. The Epinions dataset is built from a who-trust-whom online social network of a general consumer review site.

The model training then trains the ML models using each of the executed workload samples and on all datasets in the corpus (block 203). Thereafter, operation ends (block 204). The purpose of this stage is to gather the performance information for the datasets using different configurations. This way, for each dataset there is enough information about the performance dimensions. Each sample in the dataset consists of the following fields:
1. Dataset specific features:
   a. Table specific: table cardinality, engine type (such as InnoDB), whether partitioned or not, whether primary key is defined or not, average row length in bytes.
   b. Columns specific: data type, average length (estimated or actual), generation type (such as virtual or generated).
   c. Indexes and constraints: index type such as B-Tree or spatial, index size, index columns (sequence), constraints on tables and columns, constraint type (such as foreign key).
2. Workload specific features:
   a. Query specific: query type (select/update/insert/delete), query execution times, number of occurrences, query text, number of rows examined/affected/sent per query, lock times, join keys, where clause (equality, range, etc.), used or selected columns, sort keys.
   b. Operator specific: table name, filter conditions, access type (full table scan, index scan, index lookup, etc.), index used (if any), index columns used, estimate of number of rows, filter percentage, whether covering index is used.

Once the features are gathered across all datasets, we will train the ML models on the dataset. The model is an ensemble of rules followed by five piecewise linear regression models. We then train a set of model R on dataset M with targets being set to operator level execution times and save the model for later use in inference stage.

FIG. 3 is a block diagram illustrating a machine learning based index advisor for generating index recommendations in accordance with an illustrative embodiment. The machine learning models 330 are trained to predict operator level performance impact of indexes. Machine learning models 330 include a table scan model 331, a filter model 332, an index lookup/scan model 333, a sort model 334, and an index maintenance model 335. Table scan model 331 predicts the time it takes to scan each row in a table sequentially. Filter model 332 predicts the time to filter rows. Index lookup/scan model 333 predicts the time to lookup/scan rows in a secondary index. Sort model 334 predicts the time to sort rows. Index maintenance model 335 predicts the overhead or cost of maintaining an index.

Each model uses a subset of features selected from dataset specific features 310 and workload specific features 320. These features include table rows, input rows, output rows, avg row length in base table, index columns size, used columns size, sorted columns size, primary key columns size, secondary index used columns size, whether primary key is defined (these features may differ for pre-index and post-index case). The ML models 330 can then be used to generate an index recommendation 350. The performance impact of creating a candidate index is estimated by combining the relevant model predictions along with a decision tree constructed to predict the index usage.

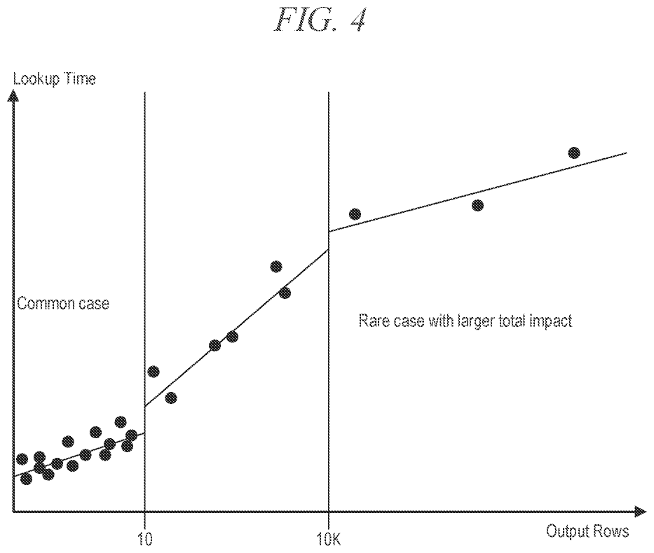

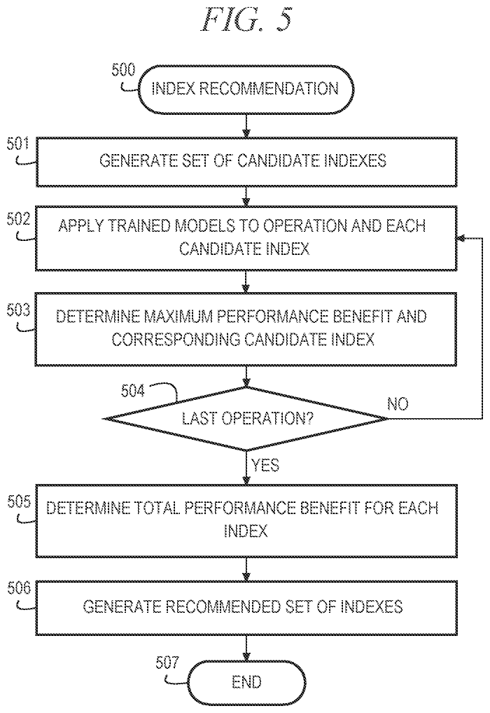

In some embodiments, ML models 330 are trained as piecewise linear regression models based on the number of output rows. In other embodiments, the models may be based on decision trees, random forests, and various adaptions thereof (ElasticNet, Ridge/Lasso Regression, LinearTrees, LinearForest, Multivariate Adaptive Regression Splines MARS, etc.). FIG. 4 illustrates an example of piecewise linear regression models based on the number of rows in accordance with an illustrative embodiment. In the example depicted in FIG. 4, a given model can be trained with the samples with fewer than 10 output rows (the common case) to form a first instance of the model, trained with the samples with between 10 and 10,000 output rows to form a second instance of the model, and trained with the samples with greater than 10,000 output rows (the rare case with larger total impact) to form a third instance of the model. The piecewise linear models are used because often queries that return few rows are most likely to benefit from indexes. The data collected was concentrated around the origin (few milliseconds query times). Piecewise models allow the index advisor to focus on most common cases but also cover rare cases that take longer and as such have a bigger influence. In addition, linear models are interpretable and easier to maintain.

Indexes can improve query performance substantially; however, they come at the cost of requiring additional storage. A model is built to predict the size of an index without needing to create the index. This allows users to account for the storage-performance trade-off before applying suggestions. The trained model achieves on average 7% MAPE (mean absolute percentage error) with a worst-case 25% MAPE. The model incorporates an overhead factor that accounts for the following phenomenon: indexes are stored efficiently at time of creation, but space efficiency gets traded off for faster updates as more data is inserted, requiring more storage in long-term.

### Index Recommendation

FIG. 5 is a flowchart illustrating an index advisor generating an index recommendation in accordance with an illustrative embodiment. Operation begins for the index advisor to generate an index recommendation (block 500), and the index advisor generates asset of candidate indexes (block 501).

### Generating Candidate Indexes

The query history contains a set of executed query digests. A digest is a normalized version of the query with any literals removed (for example, “SELECT*FROM t1 WHERE c1=?” query with attached condition “c1=1” and “c1=2” both belong to the same digest). Each digest represents a class of queries and an associated “query sample text.” Using the query sample, the optimizer can generate a machine-readable query plan which provides information about the tables accessed by the query. From each query plan, a list of tables is extracted, along with a list of statistics or features such as table name, alias name, schema name, access type (table scan or index lookup), and filter conditions, if any.

The query history also consists of post execution statistics for each digest such as minimum, average, and maximum query execution times, wait times for locks, number of rows returned, number of rows examined, number of rows sorted, etc. Using the extracted statistics, for each base table in the dataset, a list of candidate indexes is generated based on the access type and attached conditions extracted from the query plans. The candidate indexes include:
1. Candidates on filter columns: First, candidates are generated on columns that belong to the filter conditions or WHERE clause of queries. For example, a table “t1” with filter “c1=1 and c2=2”, leads to an index candidate “c1, c2” columns. Some additional checks on access type are added to avoid redundant indexes, for example, in case a query already uses a good index for lookup or filters on primary key of a table, which is also an index structure, making a secondary index on primary keys redundant.
2. Candidates on sort columns: Indexes defined on ORDER BY columns of a query, can help improve performance of sort operations, by ordering the rows in advance. Hence, index candidates are generated on sort fields, if, all sort columns belong to the same table, there are no range predicates or join keys, all the columns are sorted in the same direction (ascending or descending).
3. Candidates on used columns: Covering index candidate is generated by including all the columns used in the query for the table.

The order of columns is important for indexes. To order the columns in a candidate index, following mechanisms are used:
1. Equality keys: These tend to be the most selective, hence place them to the left in the index candidates.
2. Range or sort keys: only a single range column can be used per index. One candidate per range column is generated, with the range column being the right-most column. If no range predicates exist, then sort keys are appended to the end of the index candidates.
3. Selectivity of columns: The most selective columns should be towards the left of the index candidates, thereby improving the speed of index lookup.

The number of candidates depends on the number of distinct query digests, which is usually low for OLTP workloads. However, the number of candidates is further reduced by merging index candidates. Two indexes can be merged if one is a left prefix of another candidate. For example, index on column “c1” can be merged with index on column “c1, c2”. When appending a new index candidate, it is first compared with the list of pre-existing candidates and then merged if it satisfies the left-prefix criterion. To introduce some flexibility in the index candidates, each candidate has an associated ordering array to represent interchangeable columns.

### Inference for Performance Prediction Given Index Candidates

For each operation in the workload, the index advisor applies the trained models (models 331-335 in FIG. 3) to the operation and each candidate index (block 502). The index advisor determines the maximum performance benefit for the operation and the candidate index corresponding to the maximum performance benefit (block 503). The index advisor determines whether the operation is the last operation in the workload (block 504). If the operation is not the last operation in the workload (block 504:NO), then operation returns to block 502 to apply the trained models to the next operation.

If the operator is the last operator in the workload (block 504:YES), then the index advisor determines the total performance benefit for each candidate index (block 505). For each index candidate, the performance benefit is predicted using the ML models by summing over the predicted operator times for every table operation in the workload given the index candidates (without creating the indexes). Example pseudocode for performance benefit inference for each query in workload W for index candidates Idx_{candidates} is shown in Algorithm 1, as follows:

```
Input: Trained and tuned model for performance benefit Rperf, set of new
index candidates Idxcandidates, extracted workload feature vectors
Wtbl={t1,t2,...tn}
Output: Performance benefit estimate (and respective index candidate that
achieves the maximum benefit, if any) for each table operation in
workload
S*ₖ ← 0 // initialized to zero
  Idx*ₖ ← Null
f. ← ϕ // feature vector input to model
For tₖ in W_{tbl} do:
  // only one index can be used per table operation
    For Idxᵢ in Idx_{candidates}
      fₖ ← [tₖ, Idxᵢ]
      Sᵢ ← R_{perf} (fₖ)
    // calculate the maximum estimated performance benefit
      If S*ₖ < Sᵢ
        Idx*ₖ ← Idxᵢ
        S*ₖ ← Sᵢ
```

The index advisor then generates the recommended set of indexes (block 506), and operation ends (block 507). Example pseudocode for index selection for workload W is shown in Algorithm 2, as follows:

```
Input: Current index Idx*, set of candidate indexes Idx_{candidates}, workload
W_{*} = {q₁, q₂, ..., q_{M}}
Output: Recommended new indexes Idx_{new} and estimated total
performance benefit S*
W_{tbl} ← Ø, S* = 0, Idx_{new} ← Ø
For qₖ in W_{*} do:
  W_{tbl}^{k} ← Extract features for all tables accessed in query qₖ
  Add W_{tbl}^{k} to W_{tbl}
  S*ₖ, Idx*ₖ ← Estimated benefit and best candidate for table operations
  using Algorithm 1
For Idxᵢ in Idx_{candidates} do:
  Sᵢ ← 0 // Total estimated performance benefit of creating index
  candidate
  For tₖ in W_{tbl} do:
    IF Idx*ₖ = Idxᵢ then
      Sᵢ ← Sᵢ + S*ₖ
  IF Sᵢ > 0 then
    Add Idxᵢ to Idx_{new}
    S* ← S* + Sᵢ
Return Idx_{new}, S*
```

In accordance with some embodiments, index selection rules can further be improved by ranking index candidates by estimated performance benefit and storage requirements, and then picking the top ones that fit in storage and number of indexes budgets as follows:
1. Storage budget: For example, 4 times the base table storage minus storage required for existing indexes.
2. Number of indexes: For example, 10 indexes per table.

The Index advisor can be invoked by the user via the interface as follows:
CALL autopilot index_advisor(JSON OBJECT(‘target_schema’, JSON ARRAY (‘tpcc’)));

Where target_schema allows the user to specify a list of target schemas.

In some embodiments, the index advisor generates an explanation for the index recommendation. The explanation may include the operations in the workload that benefit from a created index or the storage savings for a dropped index. In another embodiment, the index advisor automatically implements the index recommendations. The index advisor may communicate with the database system to provide instructions for creating or dropping indexes.

### Results

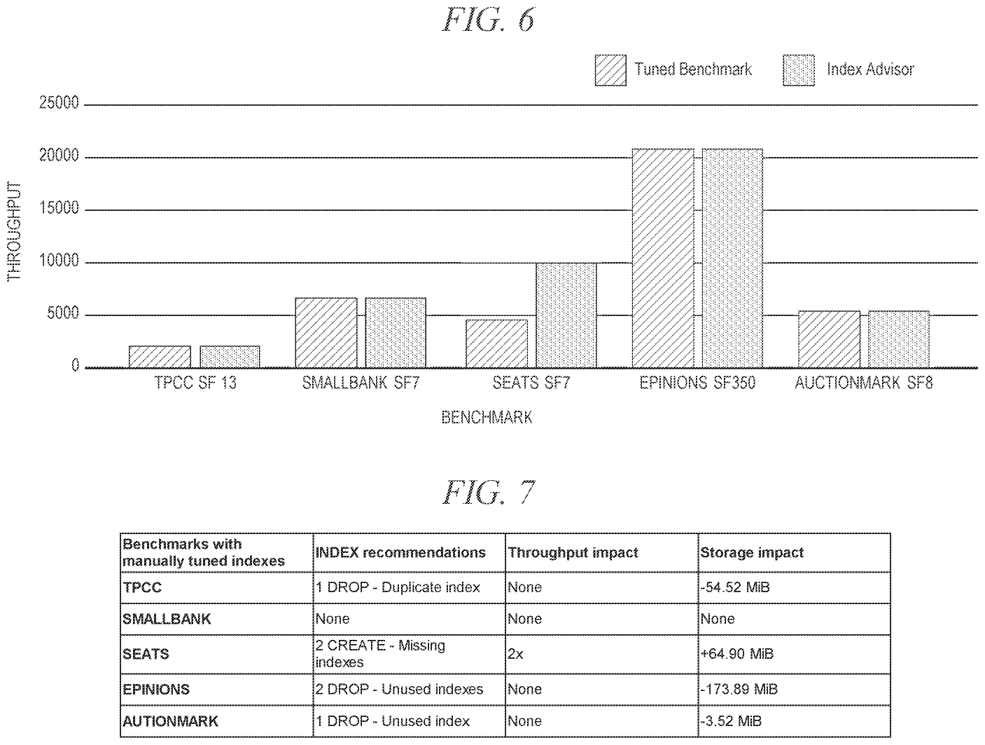

FIG. 6 illustrates the benefits of using an index advisor in accordance with the illustrative embodiments. In FIG. 6, the performance benefits of the index advisor of the illustrative embodiments are measured by using industry-standard OLTP benchmarks, which by default contain good, hand-tuned indexes. The benchmarks with no secondary indexes are run to test the index advisor capabilities. The index advisor recommends the optimal indexes that match the performance of the hand-tuned benchmarks, proving that the index advisor identifies indexes as good as the expert tunning. The index advisor recommends indexes whose performance is at par or better than manually tuned benchmarks. In some cases, the index advisor recommends fewer indexes, which saves storage.

FIG. 7 shows a table presenting results after running the index advisor on already-tuned benchmark configurations at system start in accordance with an illustrative embodiment. In this scenario, the index advisor detects the unused indexes as well as, in certain cases, improve the performance beyond the hand-tuned index configuration (e.g., SEATS benchmark). For the SmallBank benchmark, the index advisory makes no recommendation. For the SEATS benchmark, the index advisory recommends creating two missing indexes, which results in doubling the throughput. For the TPCC, Epinions, and AuctionMark benchmarks, the index advisor recommends dropping one or more indexes, which results in storage savings. Therefore, for the benchmarks that did not result in positive throughput impact, cropping unused indexes resulted in storage savings.

Consider a customer case study that includes a cloud customer migrating from a different cloud provider, expected query execution to complete in less than 2 seconds each to meet expected throughput rate. However, the customer was observing high query latencies of 30+ seconds. The tables had 12-200 million rows, but the customer had no relevant indexes so mostly queries scanned entire tables which took several minutes. The index advisor recommended creating eight new indexes, which led to great increases in speed, and the queries executed in sub seconds. This allowed the customer to meet their throughput requirement.

The index advisor is not only able to rapidly identify indexes required for an OLTP workload, but it could also further improve performance even when the baseline system is already tuned.

### Hardware Overview

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

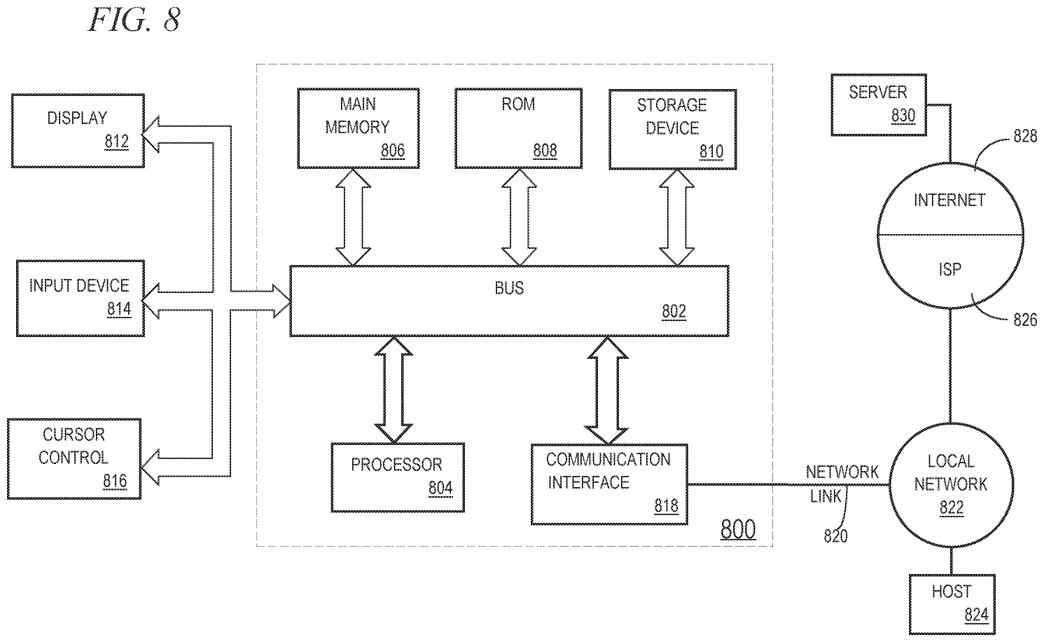

For example, FIG. 8 is a block diagram that illustrates a computer system 800 upon which aspects of the illustrative embodiments may be implemented. Computer system 800 includes a bus 802 or other communication mechanism for communicating information, and a hardware processor 804 coupled with bus 802 for processing information. Hardware processor 804 may be, for example, a general-purpose microprocessor.

Computer system 800 also includes a main memory 806, such as a random-access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read only memory (ROM) 808 or other static storage device coupled to bus 802 for storing static information and instructions for processor 804. A storage device 810, such as a magnetic disk, optical disk, or solid-state drive is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 810. Volatile media includes dynamic memory, such as main memory 806. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid-state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic, or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world-wide packet data communication network now commonly referred to as the “Internet” 828. Local network 822 and Internet 828 both use electrical, electromagnetic, or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution.

### Software Overview

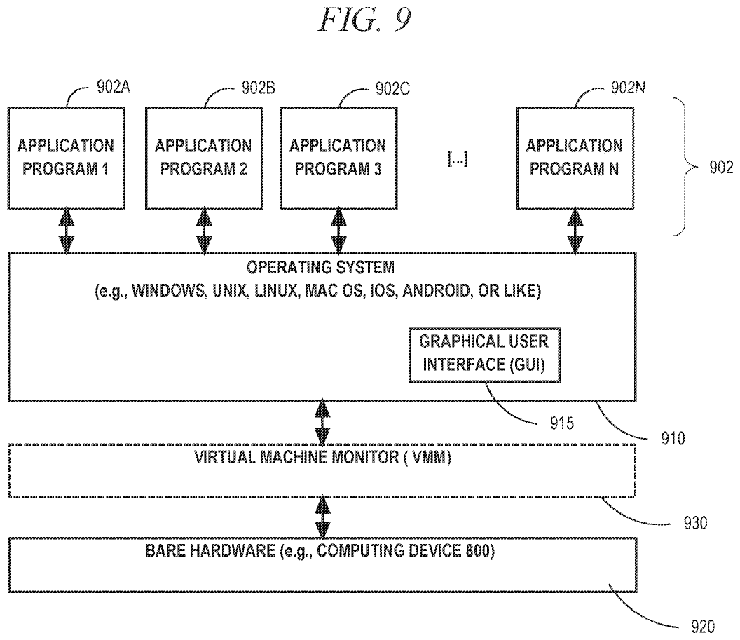

FIG. 9 is a block diagram of a basic software system 900 that may be employed for controlling the operation of computer system 800. Software system 900 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 900 is provided for directing the operation of computer system 800. Software system 900, which may be stored in system memory (RAM) 806 and on fixed storage (e.g., hard disk or flash memory) 810, includes a kernel or operating system (OS) 910.

The OS 910 manages low-level aspects of computer operation, including managing execution of processes, memory allocation, file input and output (I/O), and device I/O. One or more application programs, represented as 902A, 902B, 902C . . . 902N, may be “loaded” (e.g., transferred from fixed storage 810 into memory 806) for execution by system 900. The applications or other software intended for use on computer system 800 may also be stored as a set of downloadable computer-executable instructions, for example, for downloading and installation from an Internet location (e.g., a Web server, an app store, or other online service).

Software system 900 includes a graphical user interface (GUI) 915, for receiving user commands and data in a graphical (e.g., “point-and-click” or “touch gesture”) fashion. These inputs, in turn, may be acted upon by the system 900 in accordance with instructions from operating system 910 and/or application(s) 902. The GUI 915 also serves to display the results of operation from the OS 910 and application(s) 902, whereupon the user may supply additional inputs or terminate the session (e.g., log off).

OS 910 can execute directly on the bare hardware 920 (e.g., processor(s) 804) of computer system 800. Alternatively, a hypervisor or virtual machine monitor (VMM) 930 may be interposed between the bare hardware 920 and the OS 910. In this configuration, VMM 930 acts as a software “cushion” or virtualization layer between the OS 910 and the bare hardware 920 of the computer system 800.

VMM 930 instantiates and runs one or more virtual machine instances (“guest machines”). Each guest machine comprises a “guest” operating system, such as OS 910, and one or more applications, such as application(s) 902, designed to execute on the guest operating system. The VMM 930 presents the guest operating systems with a virtual operating platform and manages the execution of the guest operating systems.

In some instances, the VMM 930 may allow a guest operating system to run as if it is running on the bare hardware 920 of computer system 800 directly. In these instances, the same version of the guest operating system configured to execute on the bare hardware 920 directly may also execute on VMM 930 without modification or reconfiguration. In other words, VMM 930 may provide full hardware and CPU virtualization to a guest operating system in some instances.

In other instances, a guest operating system may be specially designed or configured to execute on VMM 930 for efficiency. In these instances, the guest operating system is “aware” that it executes on a virtual machine monitor. In other words, VMM 930 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
generating an index recommendation for an input dataset and input workload using a trained index recommendation model, wherein:
the input dataset comprises a set of database tables,
the input workload comprises a set of database operations to be performed on the set of database tables,
generating the index recommendation comprises:
generating a set of candidate indexes based on the input dataset;
for each given operation in the set of database operations:
applying the trained index recommendation model to the given operation and each given index in the set of candidate indexes to determine a predicted performance benefit of the given index for the given operation; and
determining a maximum predicted performance benefit and a particular index from the set of candidate indexes corresponding to the maximum predicted performance benefit;
determining a total performance benefit for each index in the set of candidate indexes based on the determined maximum predicted performance benefits for the set of database operations; and
generating a recommended set of indexes based on the total performance benefit for each index in the set of candidate indexes,
wherein the method is performed by one or more computing devices.

2. The method of claim 1, wherein generating the index recommendation further comprises ranking the set of candidate indexes by total performance benefit and selecting the recommended set of indexes from the ranked set of candidate indexes.

3. The method of claim 2, wherein generating the index recommendation further comprises selecting the recommended set of indexes from the ranked set of candidate indexes that fit within a storage budget.

4. The method of claim 1, further comprising:
training the index recommendation model by:
generating a set of workload samples and a set of dataset variations;
gathering query times for the set of workload variations executed on the set of dataset variations to form a training dataset comprising a set of dataset specific features and a set of workload specific features; and
training the index recommendation model using the training dataset.

5. The method of claim 4, wherein generating the set of workload samples and the set of dataset variations comprises using one or more benchmarks to execute the set of workload samples on the set of dataset variations.

6. The method of claim 4, wherein generating the set of workload samples and the set of dataset variations comprises generating a set of random and default queries based on the set of dataset variations.

7. The method of claim 4, wherein the set of dataset specific features comprises:
table specific features of a table including one or more of table cardinality, engine type, indication of whether the table is partitioned, indication of whether a primary key is defined, average row length,
column specific features including one or more of data type, average length, or generation type, and
index and constraint features including one or more of index type, index size, index columns, constraints on tables and columns, or constraint type.

8. The method of claim 4, wherein the set of workload specific features comprises:
query specific features including one or more of query type, query execution time, number of occurrences, query text, number of rows examined, affected, or sent per query, lock times, join keys, where clause, used or selected columns, or sort keys, and
operator specific features including one or more of table name, filter condition, access type, index used, index columns used, estimate of number of rows, filter percentage, or an indication of whether covering index is used.

9. The method of claim 1, wherein the index recommendation model comprises an ensemble of rules and a set of machine learning (ML) models.

10. The method of claim 9, wherein the set of ML models includes:
a table scan model that predicts a time it takes to scan each row in a table sequentially,
a filter model that predicts a time it takes to filter rows,
an index lookup or scan model that predicts a time it takes to lookup or scan rows in a secondary index,
a sort model that predicts a time it takes to sort rows, and
an index maintenance model that predicts overhead or cost of maintaining the secondary index.

11. The method of claim 10, wherein:
each ML model in the set of ML models is a piecewise linear regression model, and
each piecewise linear regression model is trained using a training dataset partition having a corresponding range of numbers of output rows.

12. The method of claim 10, wherein each ML model within the set of ML models uses a subset of input features including one or more of the following:
table rows,
input rows,
output rows,
average row length in base table,
index column size,
used column size,
sorted column size,
primary key column size,
secondary index used column size, or
an indicator of whether a primary key is defined.

13. The method of claim 10, wherein the set of ML models includes a storage model that predicts a size of a candidate index.

14. The method of claim 1, wherein generating the set of candidate indexes comprises generating the set of candidate indexes based on statistics extracted from query plans generated for queries in a query history.

15. The method of claim 14, wherein generating the set of candidate indexes further comprises generating the set of candidate indexes based on filter columns, sort columns, or used columns in the query history.

16. The method of claim 1, wherein generating the index recommendation further comprises identifying one or more database operations affected by each index in the recommended set of indexes.

17. A method comprising:
training an index recommendation model for generating an index recommendation by:
generating a set of workload samples and a set of dataset variations;
gathering query times for the set of workload variations executed on the set of dataset variations to form a training dataset comprising a set of dataset specific features and a set of workload specific features; and
training the index recommendation model using the training dataset, wherein the index recommendation model comprises an ensemble of rules and a set of machine learning (ML) models;
generating an index recommendation for an input dataset and input workload using the trained index recommendation model, wherein:
the input dataset comprises a set of database tables,
the input workload comprises a set of database operations to be performed on the set of database tables,
generating the index recommendation comprises:
generating a set of candidate indexes based on the input dataset;
applying the trained index recommendation model to the set of database operations and the set of candidate indexes to determine a recommended set of indexes based on a total performance benefit for each index in the set of candidate indexes,
wherein the method is performed by one or more computing devices.

18. The method of claim 17, wherein generating the set of workload samples and the set of dataset variations comprises using one or more benchmarks to execute the set of workload samples on the set of dataset variations.

19. The method of claim 17, wherein generating the set of workload samples and the set of dataset variations comprises generating a set of random and default queries based on the set of dataset variations.

20. The method of claim 17, wherein the set of dataset specific features comprises:
table specific features of a table including one or more of table cardinality, engine type, indication of whether the table is partitioned, indication of whether a primary key is defined, average row length,
column specific features including one or more of data type, average length, or generation type, and
index and constraint features including one or more of index type, index size, index columns, constraints on tables and columns, or constraint type.

21. The method of claim 17, wherein the set of workload specific features comprises:
query specific features including one or more of query type, query execution time, number of occurrences, query text, number of rows examined, affected, or sent per query, lock times, join keys, where clause, used or selected columns, or sort keys, and
operator specific features including one or more of table name, filter condition, access type, index used, index columns used, estimate of number of rows, filter percentage, or an indication of whether covering index is used.

22. The method of claim 17, wherein the set of ML models includes:
a table scan model that predicts a time it takes to scan each row in a table sequentially,
a filter model that predicts a time it takes to filter rows,
an index lookup or scan model that predicts a time it takes to lookup or scan rows in a secondary index,
a sort model that predicts a time it takes to sort rows, and
an index maintenance model that predicts overhead or cost of maintaining the secondary index.

23. The method of claim 22, wherein:
each ML model in the set of ML models is a piecewise linear regression model, and
each piecewise linear regression model is trained using a training dataset partition having a corresponding range of numbers of output rows.

24. The method of claim 22, wherein each ML model within the set of ML models uses a subset of input features including one or more of the following:
table rows,
input rows,
output rows,
average row length in base table,
index column size,
used column size,
sorted column size,
primary key column size,
secondary index used column size, or
an indicator of whether a primary key is defined.

25. The method of claim 22, wherein the set of ML models includes a storage model that predicts a size of a candidate index.

26. One or more non-transitory storage media storing instructions which, when executed by one or more computing devices, cause:
generating an index recommendation for an input dataset and input workload using a trained index recommendation model, wherein:
the input dataset comprises a set of database tables,
the input workload comprises a set of database operations to be performed on the set of database tables,
generating the index recommendation comprises:
generating a set of candidate indexes based on the input dataset;
for each given operation in the set of database operations:
applying the trained index recommendation model to the given operation and each given index in the set of candidate indexes to determine a predicted performance benefit of the given index for the given operation; and
determining a maximum predicted performance benefit and a particular index from the set of candidate indexes corresponding to the maximum predicted performance benefit;
determining a total performance benefit for each index in the set of candidate indexes based on the determined maximum predicted performance benefits for the set of database operations; and
generating a recommended set of indexes based on the total performance benefit for each index in the set of candidate indexes.
